(19) United States
(12) Patent Application Publication
(10) Pub. No.: US 2015/0346778 A1
(43) Pub. Date: Dec. 3, 2015

(54) ELECTRONIC DEVICE

(71) Applicants: SHENZHEN FUTAIHONG PRECISION INDUSTRY CO., LTD., Shenzhen (CN); FIH (HONG KONG) LIMITED, Kowloon (HK)

(72) Inventors: NAI-LIN YANG, New Taipei (TW); BING ZHANG, Shenzhen (CN); QIANG WANG, Shenzhen (CN); SHAO-LIN YANG, Shenzhen (CN); WEN-BIN SUN, Shenzhen (CN)

(21) Appl. No.: 14/551,870

(22) Filed: Nov. 24, 2014

(30) Foreign Application Priority Data
May 30, 2014 (CN) 201410236872.8

(51) Int. Cl. G06F 1/16

(52) U.S. Cl. CPC G06F 1/1658; G06F 1/1626; G06F 1/1656

(57) ABSTRACT

An electronic device includes a housing assembly and a control module. The control module is received in the housing. The control module includes a fixed assembly and a movable assembly. The fixed assembly is fixedly received in the housing assembly. The movable assembly is detachably assembled to the housing assembly.

### FIELD

The disclosure generally relates to electronic devices, and particularly to an electronic device that can be upgraded.

### BACKGROUND

Electronic devices such as mobile phones, personal digital assistants (PDAs) have become daily necessities of people. Various application software installed in the electronic device enriches functions of the electronic device. However, constantly upgrading the application software causes memory usage of the application software to become larger and larger, which leads to a lower running speed of the electronic device. To improve the running speed, a processor and a memory of the electronic device need to be upgraded.

### BRIEF DESCRIPTION OF THE DRAWINGS

Many aspects of the present disclosure can be better understood with reference to the drawings. The components in the drawings are not necessarily drawn to scale, the emphasis instead being placed upon clearly illustrating the principles of the disclosure. Moreover, in the drawings, like reference numerals designate corresponding parts throughout the views.

FIG. 1 is a perspective, diagrammatic view of an electronic device, according to an exemplary embodiment.

FIG. 2 is a disassembled view of the electronic device of FIG. 1.

FIG. 3 is an assembled view of a battery and a control module of the electronic device of FIG. 1.

FIG. 4 is similar to FIG. 3, but shown from another aspect.

FIG. 5 is an assembled view of a movable assembly of the electronic device of FIG. 1.

FIG. 6 is an assembled view of an upgraded version of the movable assembly of the electronic device of FIG. 1.

FIG. 7 is a block diagram of the electronic device of FIG. 1, according to an exemplary embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

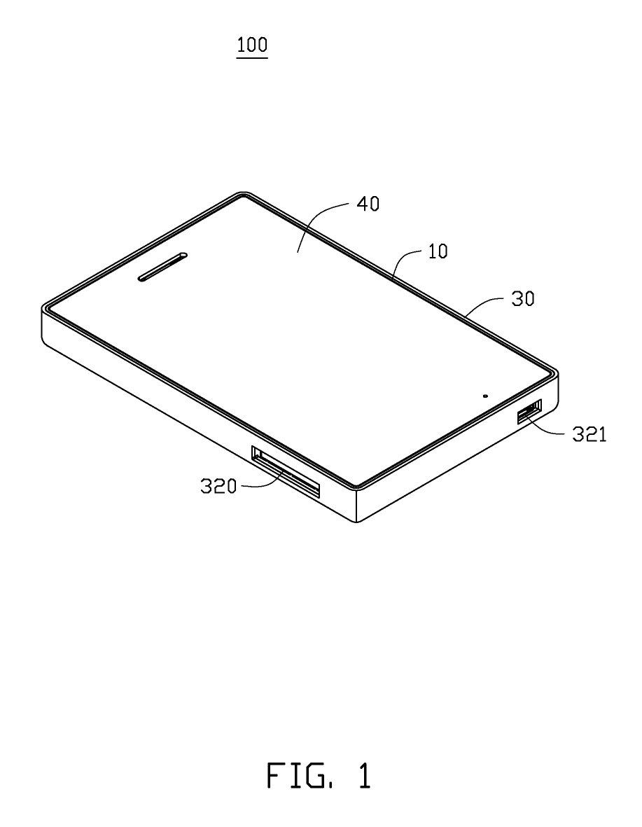

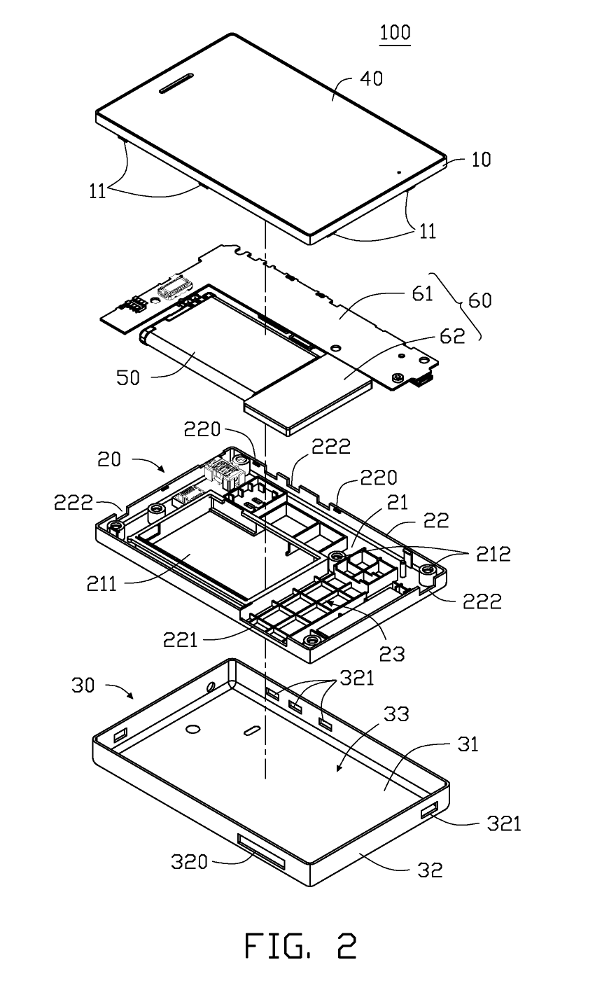

FIG. 1 is a perspective, diagrammatic view of an electronic device 100, according to an exemplary embodiment. In this exemplary embodiment, the electronic device 100 may be a mobile phone, for example. FIG. 2 shows that, the electronic device 100 includes a first housing 10, a second housing 20, a third housing 30, a display module 40, a battery 50, and a control module 60.

The first housing 10 is substantially rectangular. The display module 40 is assembled to a first side of the first housing 10. A plurality of first latching portions 11 protrude from a second side of the first housing 10 opposite to the display module 40.

The second housing 20 includes a base 21 and a first sidewall 22 extending from peripheral edges of the base 21. The base 21 and the first sidewall 22 cooperatively form a first receiving chamber 23. A receiving space 211 is defined in the base 21 to receive the battery 50. A plurality of positioning posts 212 protrude from the first receiving chamber 23. A first slot 221 and a plurality of second slots 222 are defined in the first side wall 22. A plurality of second latching portions 220 protrude from the side wall 22 toward the first receiving chamber 23. The second latching portions 220 correspond to the first latching portions 11.

The third housing 30 includes a bottom wall 31 and a second sidewall 32 extending from peripheral edges of the bottom wall. The bottom wall 31 and the second sidewall 32 cooperatively form a second receiving chamber 33. A first hole 320 and a plurality of second holes 321 are defined in the second side wall 32 corresponding to the first slot 221 and the second slots 222, respectively.

In this exemplary embodiment, the first, second, and third housings 10, 20, 30 are defined as a housing assembly. The first latching portion 11 and the second latching portions 220 are defined as latching portions. The first hole 320 and the second hole 321 are defined as holes. The first slot 221 and the second slots 222 are defined as slots.

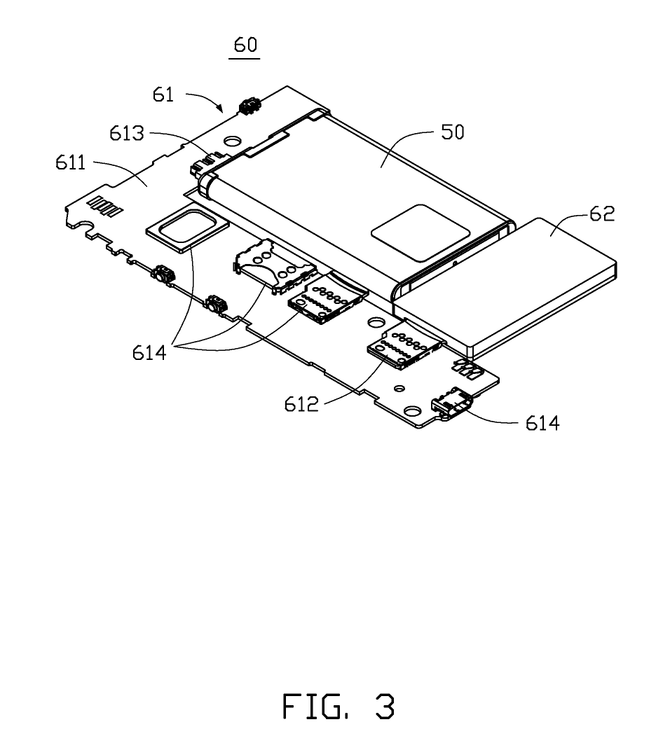

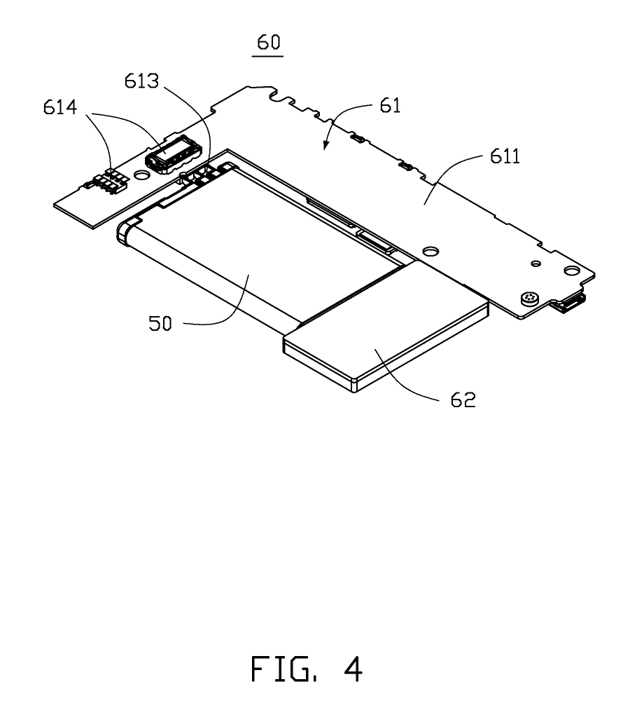

FIGS. 3 and 4 show that, the control module 60 includes a fixed assembly 61 and a movable assembly 62. The fixed assembly 61 includes a fixed main board 611, a connector 612, and a plurality of electronic members 614 such as buttons, USB interface, SIM card port, SD card port, or pins used to connect a receiver, a screen, a battery, etc to the fixed main board 611. The connector 612 and the electronic member 614 are electronically connected to each other by circuit printed on the fixed circuit board 611.

The movable assembly 62 is detachable and changeable. In this exemplary embodiment, the movable assembly 62 is a first version movable assembly.

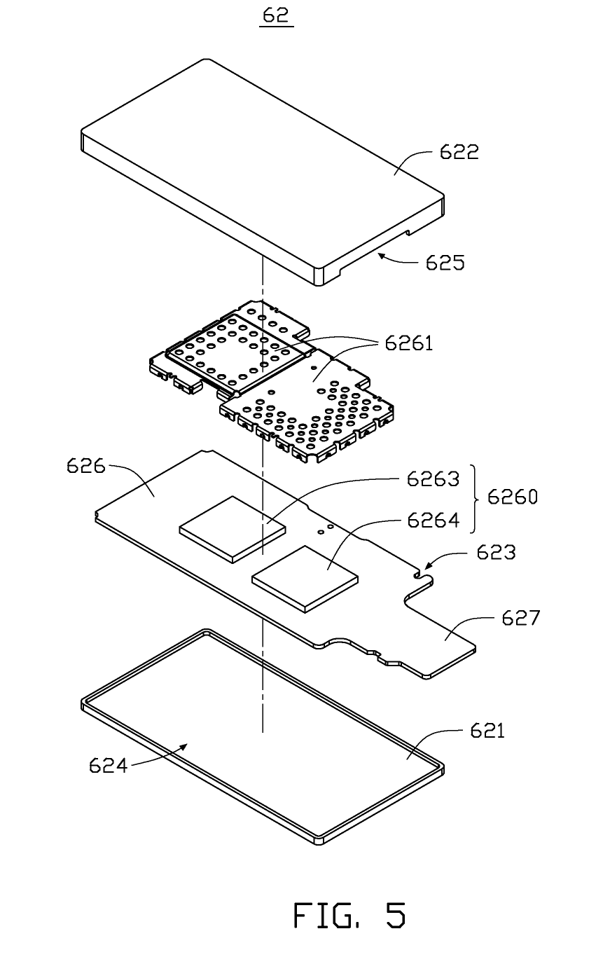

Referring to FIG. 5, the movable assembly 62 includes a first case 621, a second case 622, and a movable main board 623. The first case 621 and the second case 622 are detachably assembled together to form a receiving cavity 624. A cutout 625 is defined in a sidewall of the second case 622. In this exemplary embodiment, the first and second cases 621, 622 are defined as cases.

The movable main board 623 includes a main portion 626 and a connecting portion 627 protruding from one side of the main portion 626. The movable main board 623 is a first version main board. The main portion 626 is received in the receiving cavity 624. The connecting portion 627 is exposed from the receiving cavity 624 via the cutout 625. A plurality of microchips 6260 and a shielding cover 6261 are positioned on one side of the main portion 626. In the exemplary embodiment, the microchip 6260 includes a processor 6263 and a memory 6264. The memory 6264 stores controlling programs configured for controlling the electronic device 100. The shielding cover 6261 covers the microchips 6260 and is configured for protecting the microchips 6260 from electromagnetic interference.

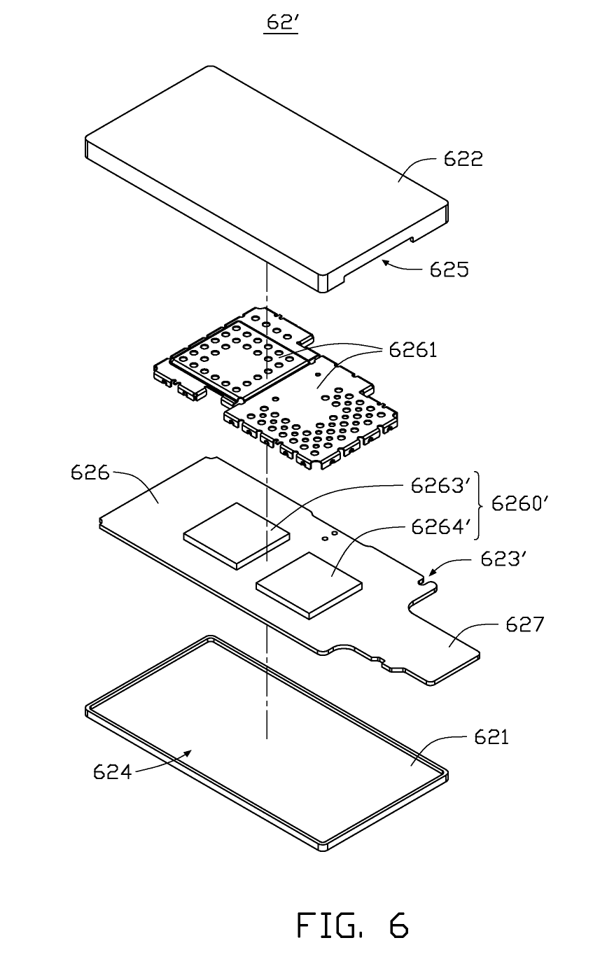

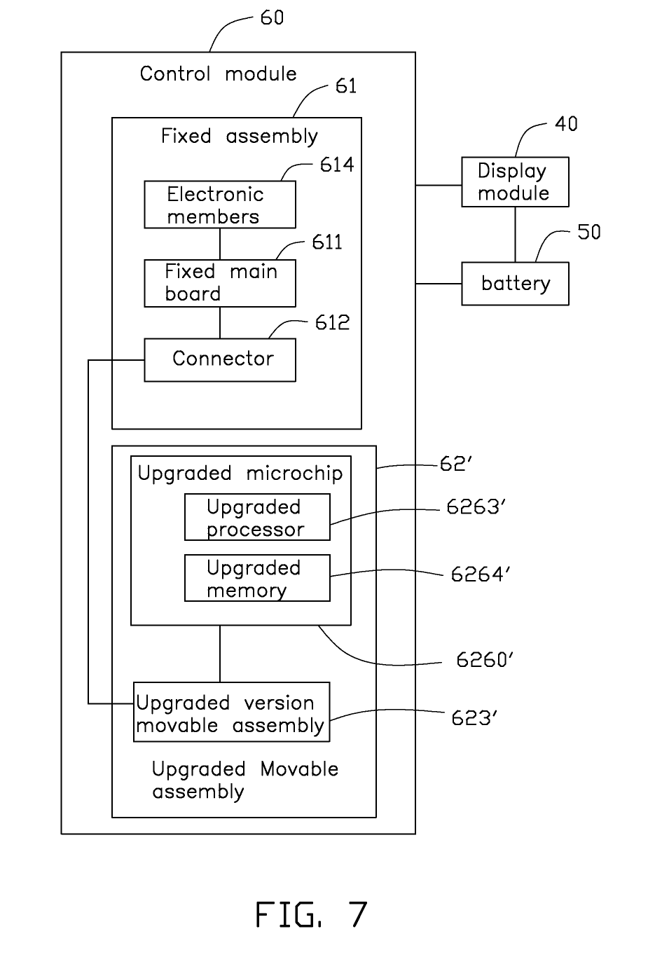

In another exemplary embodiment, the movable assembly 62 may be an upgraded version movable assembly 62′. FIGS. 6 and 7 show that the upgraded version movable assembly 62′ is substantially similar to the first version movable assembly 62 and includes a upgraded main board 623′ and a upgraded microchip 6260′. The difference is that the upgraded microchips 6260′ have an upgraded processor 6263′ and an upgraded memory 6264′ which stores upgrading software configured for upgrading the electronic device 100.

In assembly, the fixed main board 611 is secured to the positioning posts 212 by fasteners such as screws. The first latching portions 11 engage with the corresponding second latching portions 220 to latch the first housing 10 to the second housing 20. The battery 50 is received in the receiving space 211. The battery 50 is electronically connected to the fixed main board 611. The third housing 30 covers the second housing 20. The first and second housings 10, 20 are received in the second receiving chamber 33. Some of the electronic members 614 such as the buttons and the ports are exposed from the second slots 222 and the second holes 321. The movable assembly 62 is received in the first receiving chamber 23 and exposed from the first hole 320 and the first slot 221. The connecting portion 627 is inserted into the connector 612 to electronically connect the movable main board 623 to the fixed main board 611.

To upgrade the electronic device 100, the movable assembly 62 can be removed from the housing. The upgraded version movable assembly 62′ can be inserted into the housing assembly and electronically connected to the fixed assembly 61. Thus, the electronic device 100 can be conveniently upgraded by the upgraded version movable assembly 62′ and obtains a higher running speed.

It is to be understood, however, that even through numerous characteristics and advantages of the present disclosure have been set forth in the foregoing description, together with details of assembly and function, the disclosure is illustrative only, and changes may be made in the details, especially in the matters of shape, size, and arrangement of parts within the principles of the disclosure to the full extent indicated by the broad general meaning of the terms in which the appended claims are expressed.

What is claimed is:

1. An electronic device comprising:
a housing assembly;
a control module received in the housing assembly; the control module comprising:
a fixed assembly fixedly received in the housing assembly; and
a movable assembly detachably assembled to the housing assembly.

2. The electronic device of claim 1, wherein the movable assembly is one of a first version movable assembly and an upgraded version movable assembly.

3. The electronic device of claim 1, wherein the fixed assembly comprises a fixed main board, the movable assembly comprises a movable main board; the movable main board comprises a main portion and a connecting portion protruding from one side of the main portion; the connecting portion is electronically connected to the fixed main board.

4. The electronic device of claim 3, wherein the movable assembly further comprises a case defining a receiving cavity with a cutout, the main portion is received in the receiving cavity, the connecting portion is exposed from the receiving cavity via the cutout.

5. The electronic device of claim 3, wherein the main portion comprises a plurality of microchips and a shielding cover positioned on one side of the main portion, the shielding cover covers the microchips.

6. The electronic device of claim 1, further comprising a display module; wherein the housing assembly comprises a first housing and a second housing latched to the first housing, the display module is assembled to one side of the first housing, the second housing comprises a first receiving chamber, the fixed assembly is fixedly received in the first receiving chamber, the movable assembly is movably received in the first receiving chamber.

7. The electronic device of claim 6, wherein the housing assembly further comprises a third housing having a second receiving chamber, the second housing is received in the second receiving chamber, the second housing defines a plurality of slots, the third housing defines a plurality of holes corresponding to the slots, the movable assembly is exposed from the housing assembly via the slots and the holes.

8. The electronic device of claim 2, wherein the movable assembly is the first version movable assembly, the microchips comprises a processor and a memory which stores controlling programs configured for controlling the electronic device.

9. The electronic device of claim 2, wherein the movable assembly is the upgraded version movable assembly, the microchips comprises a processor and a memory which stores upgrading software configured for upgrading the electronic device.

10. An electronic device comprising:
a housing assembly;
a control module received in the housing assembly; the control module comprising:
a fixed assembly fixedly received in the housing assembly;
a first version movable assembly; and
an upgraded version movable assembly; wherein one of the first version movable assembly and the upgraded version movable assembly is detachably assembled to the housing assembly.

11. The electronic device of claim 10, wherein the first version movable assembly comprises a processor and a memory which stores controlling programs configured for controlling the electronic device.

12. The electronic device of claim 11, wherein the fixed assembly comprises a fixed main board, the first version movable assembly comprises a movable main board; the movable main board comprises a main portion and a connecting portion protruding from one side of the main portion; the connecting portion is electronically connected to the fixed main board.

13. The electronic device of claim 12, wherein the first version movable assembly further comprises a case defining a receiving cavity with a cutout, the main portion is received in the receiving cavity, the connecting portion is exposed from the receiving cavity via the cutout.

14. The electronic device of claim 13, wherein the processor and the memory are positioned on the main portion, the main portion comprises a shielding cover positioned on one side of the main portion, the shielding cover covers the processor and the memory.

15. The electronic device of claim 10, wherein the upgraded version movable assembly comprises a processor and a memory which stores upgrading software configured for upgrading the electronic device.

16. The electronic device of claim 15, wherein the fixed assembly comprises a fixed main board, the upgraded version movable assembly comprises a movable main board; the movable main board comprises a main portion and a connecting portion protruding from one side of the main portion; the connecting portion is electronically connected to the fixed main board.

17. The electronic device of claim 16, wherein the upgraded version movable assembly further comprises a case defining a receiving cavity with a cutout, the main portion is received in the receiving cavity, the connecting portion is exposed from the receiving cavity via the cutout.

18. The electronic device of claim 17, wherein the processor and the memory are positioned on the main portion, the main portion comprises a shielding cover positioned on one side of the main portion, the shielding cover covers the processor and the memory.
